(19) United States
(12) Patent Application Publication
(10) Pub. No.: US 2012/0013522 A1
(43) Pub. Date: Jan. 19, 2012

(54) MULTIBAND ANTENNA AND MULTIBAND ANTENNAE ARRAY HAVING THE SAME

(75) Inventors: TAIICHI YAMAGUCHI, Yokohama (JP); JOHN CHOW, Saratoga, CA (US); YUN-CHENG HOU, New Taipei (TW); CHANG-CHING LIN, New Taipei (TW)

(73) Assignee: HON HAI PRECISION INDUSTRY CO., LTD., New Taipei (TW)

(21) Appl. No.: 13/181,563

(22) Filed: Jul. 13, 2011

(30) Foreign Application Priority Data
Jul. 13, 2010 (TW) 99122910

(51) Int. Cl. H01Q 21/08; H01Q 9/04

(52) U.S. Cl. 343/893; 343/700 MS

(57) ABSTRACT

A multiband antenna (10) includes a grounding element (11), a feeding element (12) resonating at a first frequency band, a first parasitic radiation (13) element spaced apart from the feeding element, and a parasitic element (14) disposed between the first parasitic radiation element and the feeding element for operating at the second frequency band. The first parasitic radiation element is designed for operating at a second frequency band.

### BACKGROUND OF THE INVENTION

1. Field of the Invention

The present invention relates to a multiband antenna and multiband antennae array having such multiband antenna, and more particularly to a multiband antenna and multiband antennae array working on close frequency bands.

2. Description of Related Arts

U.S. Pat. No. 7,277,055, issued on Oct. 2, 2007, to Tamaoka discloses a multiband antenna. According to the disclosure, the multiband antenna comprises a bottom insulative layer, a top insulative layer, a middle insulative layer disposed between the bottom insulative layer and the top insulative layer, a feeding element disposed between the middle insulative layer and the top insulative layer, and a grounded parasitic element disposed between the middle insulative layer and the bottom insulative layer. The multiband antenna has a good characteristic on first frequency band (900 MHz) and second frequency band (1800 MHz). The second frequency band (1800 MHz) is about 2 times of the first frequency band (900 MHz). Therefore, it is not difficult to design such a multiband antenna. However, it is difficult to design a multiband antenna capable of working on close frequency bands. For example, WiMAX (worldwide interoperability for microwave access), a third generation mobile system services standard, defines two close working frequency bands including 2.5 GHz and 3.5 GHz.

Normally, multiband antenna of close frequency bands use RF components which are frequency divider, combiner or the like to each antenna element. Therefore, the cost of the multiband antenna is increased, and the structure of the multiband antenna becomes complex.

U.S. Pat. No. 7,746,286 issued to Suzuki on Jun. 29, 2010 discloses an antenna device having a parasictic radiation element of varied designs to improve directional characteristics.

### SUMMARY OF THE INVENTION

An object of the present invention is to provide a multiband antenna and a multiband antennae array having such a multiband antenna working on close frequency bands having low cost and simple structure.

To achieve the above-mentioned object, a multiband antenna comprises a grounding element, a feeding element resonating at a first frequency band, a first parasitic radiation element spaced apart from the feeding element, and a parasitic element disposed between the first parasitic radiation element and the feeding element for operating at the second frequency band. The first parasitic radiation element is designed for operating at a second frequency band.

According to the present invention, a multiband antennae array comprises a plurality of multiband antennae arranged in a plurality of rows and a plurality of columns. Each of the multiband antennae comprises a grounding element, a feeding element resonating at a first frequency band, a first parasitic radiation element spaced apart from the feeding element, and a parasitic element disposed between the first parasitic radiation element and the feeding element for operating at the second frequency band. The first parasitic radiation element is designed for operating at a second frequency band.

According to the present invention, the multiband antenna and the multiband antennae array having the same provide a parasitic element corresponding the second frequency band nearly to the first frequency band. Therefore, the multiband antenna and the multiband antennae array could work on close frequency bands, and have low cost, simple structure.

### BRIEF DESCRIPTION OF THE DRAWING

FIG. 1 is a perspective view of a multiband antenna in accordance with a first embodiment of the present invention;

FIG. 2 is a top view of the multiband antenna as shown in FIG. 1;

FIG. 3 is a simulation result graph showing a return loss versus frequency characteristic as shown in FIG. 1;

FIG. 4 is a perspective view of a multiband antenna in accordance with a second embodiment of the present invention;

FIG. 5 is a top view of the multiband antenna as shown in FIG. 4;

FIG. 6 is a simulation result graph showing a return loss versus frequency characteristic of the multiband antenna as shown in FIG. 4;

FIG. 7 a perspective view of a multiband antenna in accordance with a third embodiment of the present invention;

FIG. 8 is a top view of the multiband antenna as shown in FIG. 7;

FIG. 9 is a simulation result graph showing a return loss versus frequency characteristic of the multiband antenna as shown in FIG. 7;

FIG. 10 is a perspective view of a multiband antenna in accordance with a fourth embodiment of the present invention;

FIG. 11 is a top view of the multiband antenna as shown in FIG. 10;

FIG. 12 is a simulation result graph showing a return loss versus frequency characteristic of the multiband antenna as shown in FIG. 10;

FIG. 13 is a perspective view of a multiband antenna in accordance with a fifth embodiment of the present invention;

FIG. 14 is a top view of the multiband antenna as shown in FIG. 13;

FIG. 15 is a simulation result graph showing a return loss versus frequency characteristic of the multiband antenna as shown in FIG. 13;

FIG. 16 is a top view of the multiband antenna in accordance with the sixth embodiment;

FIG. 17 is a simulation result graph showing a return loss versus frequency characteristic of the multiband antenna as shown in FIG. 16;

FIG. 18 is a top view of the multiband antenna in accordance with a seventh embodiment of the present invention;

FIG. 19 is a simulation result graph showing a return loss versus frequency characteristic of the multiband antenna as shown in FIG. 18;

FIG. 20 is a top view of the multiband antenna in accordance with an eighth embodiment of the present invention;

FIG. 21 is a simulation result graph showing a return loss versus frequency characteristic of the multiband antenna as shown in FIG. 20;

FIG. 22 is a top view of multiband antennae array showing two multiband antennae as shown in FIG. 1 arranged along Y direction;

FIG. 23 is a top view of multiband antennae array showing two multiband antennae as shown in FIG. 1 arranged along X direction and Y direction;

FIG. 24 is a simulation results graph showing peak gains versus frequency characteristic of the multiband antennae array as shown in FIG. 22 with different distances between the adjacent multiband antennas;

FIG. 25 is a simulation results graph showing peak gains versus frequency characteristic of the multiband antennae array as shown in FIG. 22 with distances between the adjacent multiband antennae being equal to 100 mm and 120 mm;

FIG. 26 is a simulation results graph showing peak gains versus frequency characteristic of multiband antennae array as shown in FIG. 1 with different distances between the adjacent multiband antennae along the X direction; and

FIG. 27 is a simulation results graph showing peak gains versus frequency characteristic of the multiband antennae array as shown in FIG. 23.

### DETAILED DESCRIPTION OF THE PREFERRED EMBODIMENT

Reference will now be made in detail to a preferred embodiment of the present invention.

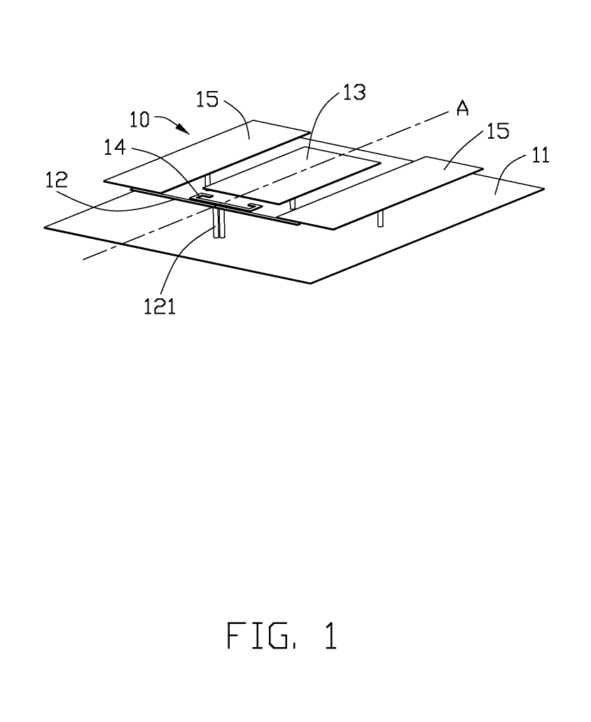

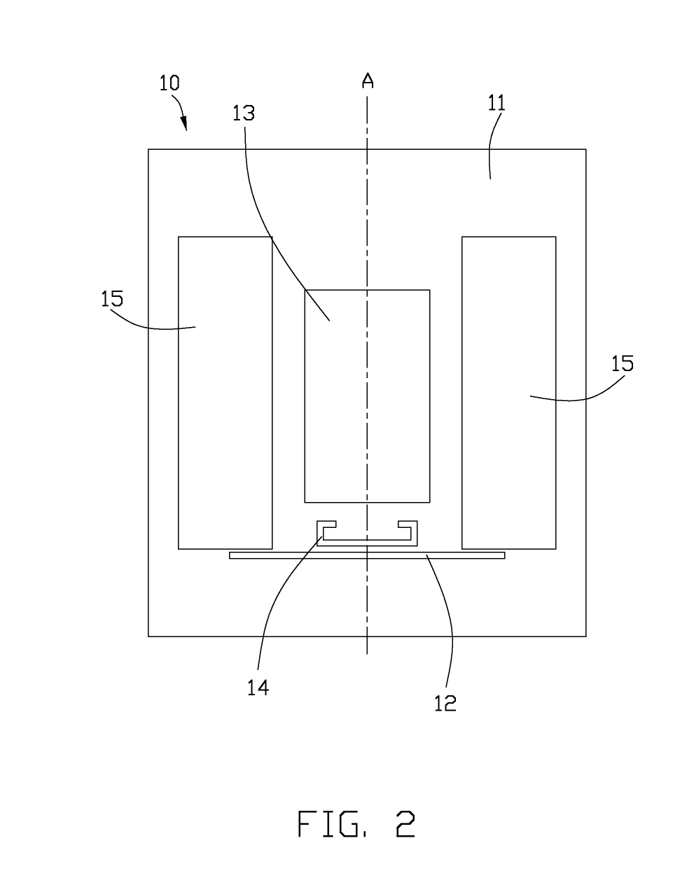

Referring to FIGS. 1 to 3, a multiband antenna 10 in accordance with a first embodiment of the present invention comprises a grounding element 11, a feeding element 12, a first parasitic radiation element 13, a parasitic element 14, and two second parasitic radiation elements 15. The grounding element 11 is disposed on a first plane. The feeding element 12, the first parasitic radiation element 13, the parasitic element 14, and the second parasitic radiation elements 15 are disposed on a second plane spaced apart from and parallel to the first plane. As an example, a distance between the first plane and the second plane is about 7 mm.

The feeding element 12 can resonate at a first frequency band. The feeding element 12 extending along a first direction comprises a connecting portion 121 in a middle thereof for connecting with a power feed line, e.g., a coaxial connector. The first parasitic radiation element 13 is designed for a second frequency band, and is disposed spaced apart from the feeding element 12. The first parasitic radiation element 13 extends along a second direction perpendicular to the first direction. The parasitic element 14 is corresponding to the second frequency band. The parasitic element 14 is disposed between the feeding element 12 and the first parasitic radiation element 13. The parasitic element 14 generally extends parallel to the feeding element 12. The first parasitic radiation element 13 is disposed on a side of the feeding element 12 and adjacent to the middle portion of the feeding element 12. The second parasitic radiation element 15 is designed for the first frequency band. The second parasitic radiation elements 15 are spaced apart from the feeding element 12, and disposed on the same side of the feeding element 12. The two second parasitic radiation elements 15 are disposed near two opposite ends of the feeding element 12, respectively. The second parasitic radiation elements 15 extend along a direction perpendicular to the first direction. The second parasitic radiation elements 15 are disposed symmetrically with each other along a line A vertical to the middle portion of the feeding element 12.

The multiband antenna 10 of the first embodiment is designed to comply with the WiMAX standard. The first frequency band is 2.3-2.7 GHz, and the second frequency band is 3.3-3.8 GHz. As the second frequency band is close to the first frequency band, it is difficult to add the second frequency band resonation on the feeding element 12. Therefore, the parasitic element 14 is used for the first parasitic radiation element 13 to work at the second frequency band. The first parasitic radiation element 13 has a length equal to a half or a quarter of a wavelength of the central frequency of the second frequency band. The second parasitic element 15 has a length equal to a half or a quarter of a wavelength of the central frequency of the first frequency band. The parasitic element 14 has a length equal to a quarter of the wavelength of the central frequency of the second frequency band.

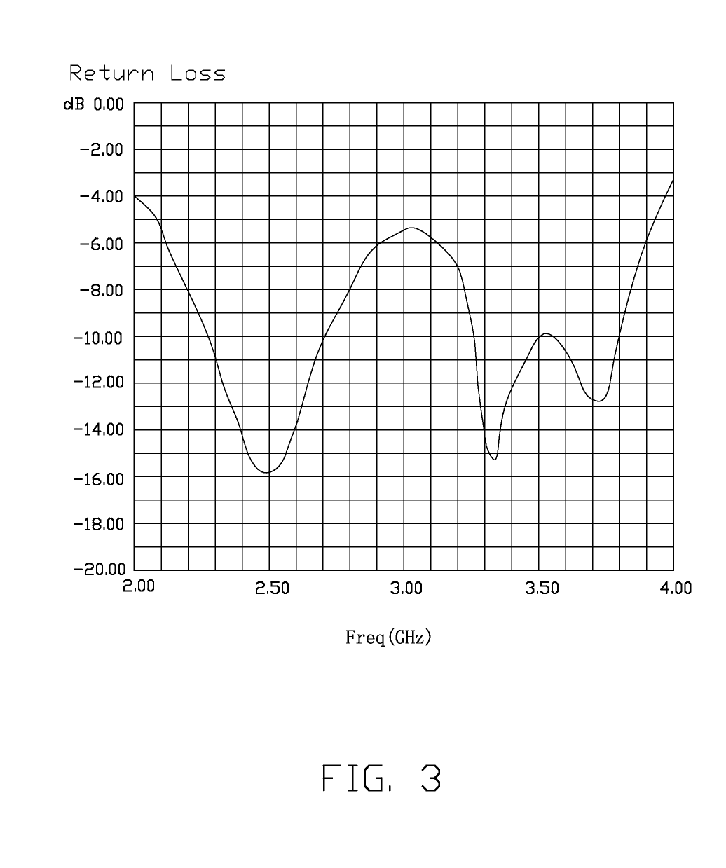

Referring to FIG. 3, a simulation result graph showing a return loss versus frequency characteristic of the multiband antenna 10 in accordance with the first embodiment. The return losses are less than −10 dB in 2.3-2.7 GHz and 3.3-3.8 GHz.

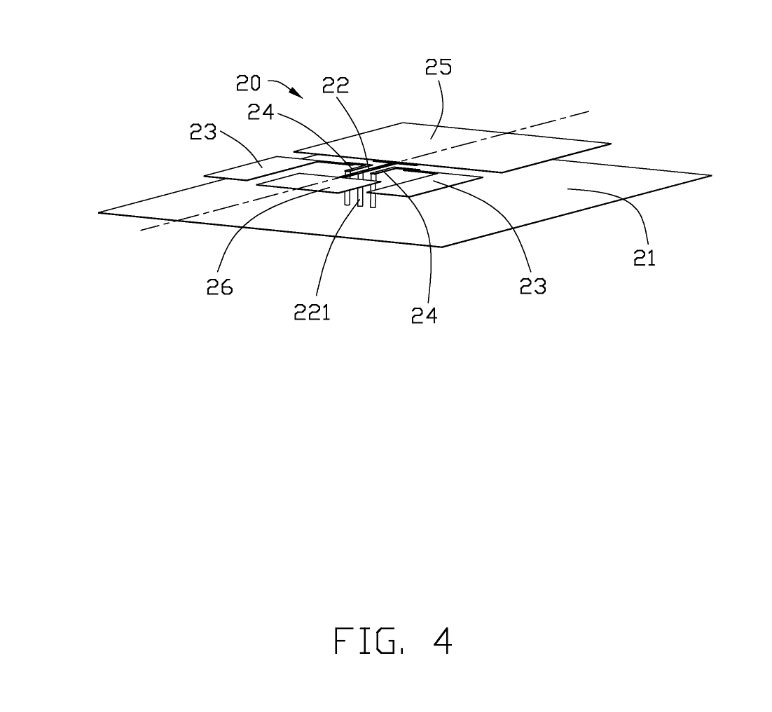

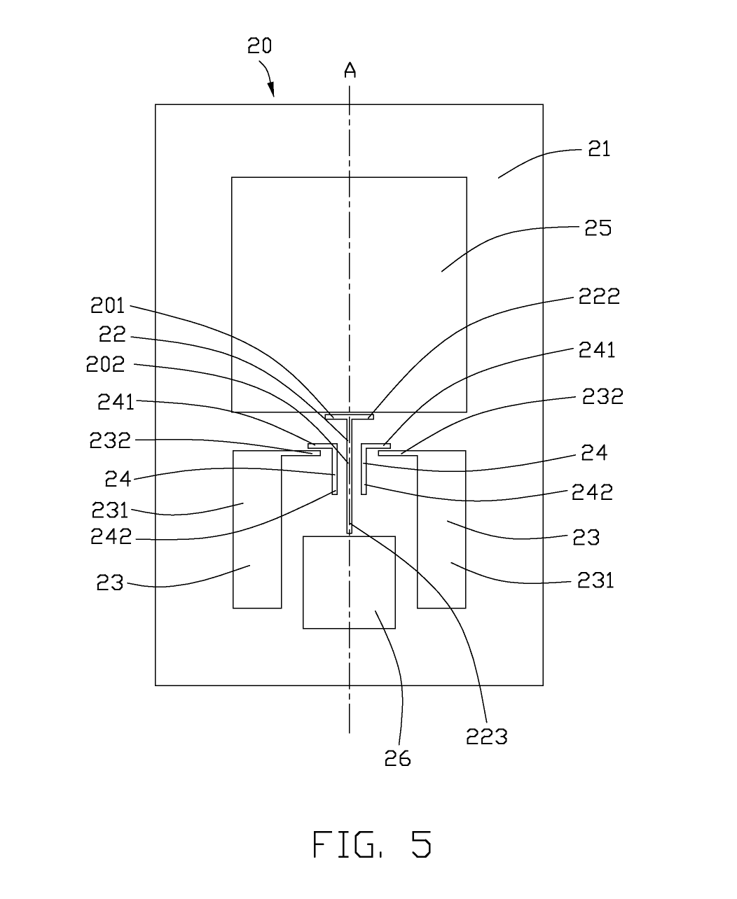

Referring to FIGS. 4 to 6, a multiband antenna 20 in accordance with a second embodiment of the present invention comprises a grounding element 21, a feeding element 22, two first parasitic radiation elements 23, two parasitic elements 24, a second parasitic radiation element 25, and a third parasitic radiation element 26. The grounding element 21 is disposed on a first plane. The feeding element 22, the first parasitic radiation elements 23, the parasitic elements 24, the second parasitic radiation element 25, and the third parasitic radiation element 26 are disposed on a second plane spaced apart from and parallel to the first plane. As an example, a distance between the first plane and the second plane is about 7 mm.

The feeding element 22 comprises a first portion 201 extending along a first direction, a second portion 202 extending along a second direction perpendicular to the first direction. The feeding portion 22 comprises a connecting portion 221 defined on the second portion 202 for connecting with a power feed line, e.g., a coaxial connector. The feeding element 22 is divided into a first resonated portion 222 and a second resonated portion 223 by the connecting portion 221. The first resonated portion 222 can resonate at a first frequency band, and the second resonated portion 223 can resonate at a third frequency band. The first parasitic radiation portions 23 are corresponding to a second frequency band. The first parasitic radiation portions 23 are disposed spaced apart from the feeding element 22. The first parasitic radiation elements 23 are disposed symmetrically with each other along an axial line A vertical to the second portion 202 of the feeding element 22. Each of the first parasitic radiation elements 23 comprises a body portion 231 extending along a direction parallel to the second portion 202, and a beam portion 232 extending from an end of the body portion 231 along a direction parallel to the first portion 201 and forwardly of the second portion 202. The two parasitic elements 24 are corresponding to the second frequency band. The parasitic elements 24 are disposed between the first parasitic radiation element 23 and the second portion 202 of the feeding element 22. Each of the parasitic elements 24 comprises a first parasitic portion 241 extending along a direction parallel to the first portion 201 of the feeding element 22, and second parasitic portion 242 extending along a direction parallel to the second portion 202 of the feeding element 22. The first parasitic element 241 is connected with the second parasitic element 242. The parasitic elements 24 are disposed symmetrically with each other along the axial line A. The second parasitic radiation element 25 is designed for the first frequency band. The second parasitic radiation element 25 is disposed at an end of and spaced apart from the first portion 201 of the feeding element 22. The second parasitic radiation element 25 extends along a direction perpendicular to the first portion 201 of the feeding element 22. The third parasitic radiation element 26 is designed for the third frequency band. The third parasitic radiation element 26 is disposed at an end of and spaced apart from the second portion 202 of the feeding element 22. The third parasitic radiation element 26 extends along the second direction.

The multiband antenna 20 of the second embodiment is according with the WiMax standard and the WiFi standard. The first frequency band is 2.3-2.7 GHz, and the second frequency band is 3.3-3.8 GHz, and the third frequency band is 5.1-5.8 GHz. The second frequency band is close to the first frequency band. Therefore, it is difficult to add the second frequency band resonation on the feeding element 22. The parasitic element 24 is used for the first parasitic radiation element 23 to work at the second frequency band. The first parasitic radiation element 23 has a length equal to a half or a quarter of a wavelength of a central frequency of the second frequency band. The second parasitic radiation element 25 has a length equal to a half or a quarter of a wavelength of a central frequency of the first frequency band. The third parasitic radiation element 26 has a length equal to a half or a quarter of a central frequency of the third frequency band. The parasitic element 24 has a length equal to a quarter of a wavelength of a central frequency band of the second frequency band.

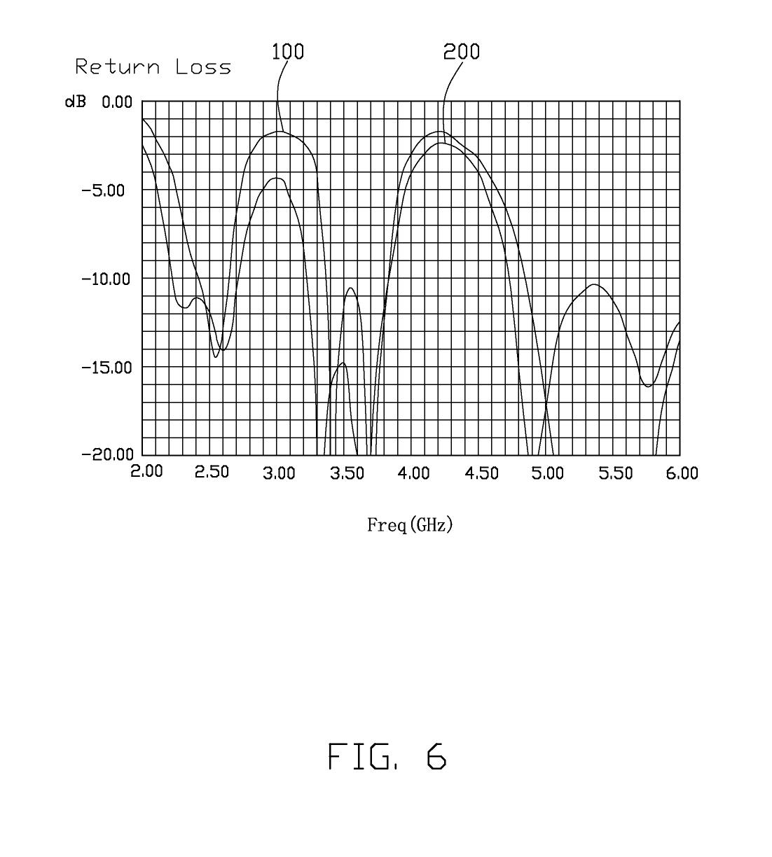

Referring to FIG. 6, a simulation result graph showing return losses versus frequency characteristic of the multiband antenna 20 in accordance with the second embodiment. The simulation result graph comprises a first curve 100 showing a return loss versus frequency characteristic of the multiband antenna 20 when the distance between the first plane and the second plane is about 5 mm, and a second curve 200 showing a return loss versus frequency characteristic of the multiband antenna 20 when the distance between the first plane and the second plane is about 7 mm. The return losses are less than −10 dB in 2.3-2.7 GHz, 3.3-3.8 GHz, and 5.1-5.8 GHz when the distance between the first plane and the second plane is about 7 mm.

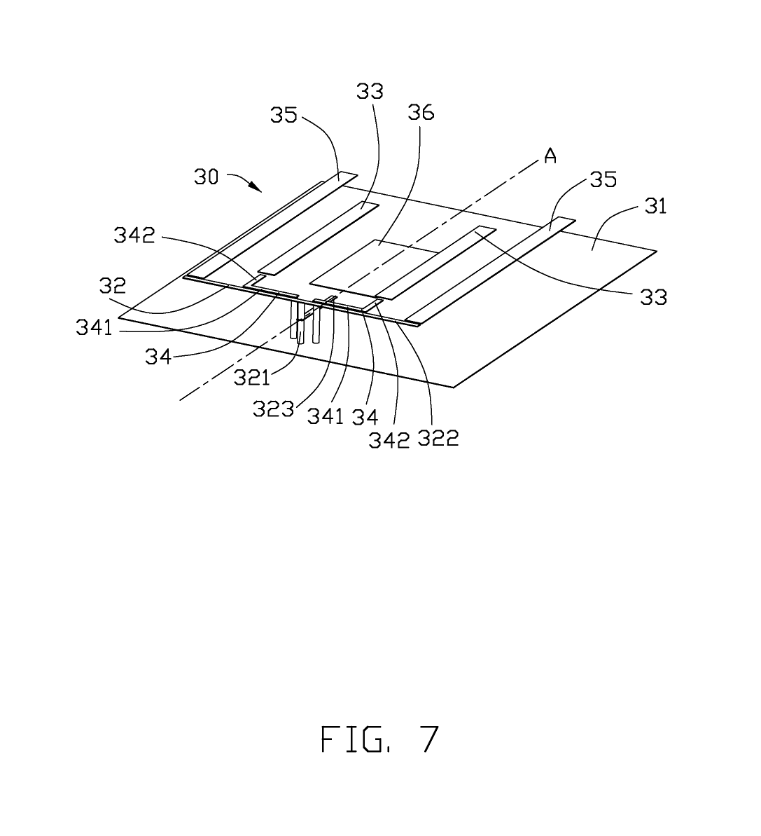

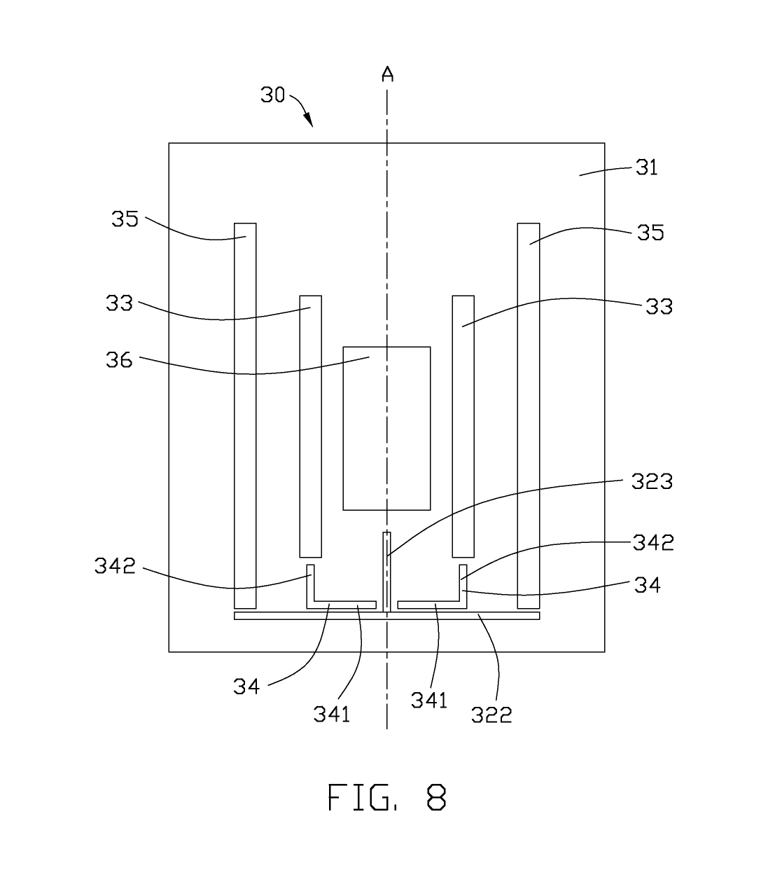

Referring to FIGS. 7 to 9, a multiband antenna 30 in accordance with a third embodiment of the present invention comprises a grounding element 31, a feeding element 32, two first parasitic radiation elements 33, two parasitic elements 34, two second parasitic radiation elements 35, and a third parasitic radiation element 36. The grounding element 31 is disposed on a first plane. The feeding element 32 comprises a connecting portion 321, a first resonated portion 322 corresponding to the first frequency, and a second resonated portion 323 corresponding to the third frequency band. The first resonated portion 322, the first parasitic radiation elements 33, the parasitic element 34 and the second parasitic radiation elements 35 are disposed on a second plane spaced apart from and parallel to the first plane. As an example, a distance between the first plane and the second plane is about 7 mm. The second resonated portion 323 and the third parasitic radiation element 36 are disposed on a third plane between the first plane and the second plane. As an example, a distance between the first plane and the third plane is about 4 mm.

The first resonated portion 322 of the feeding element 32 extends along a first direction. The connecting portion 321 connects with a middle portion of the first resonated portion 322. The second resonated portion 323 connects with the connecting portion 321 and extends along a direction perpendicular to the first direction. The feeding element 321 could connect with a power feed line, e.g., a coaxial connector. The two first parasitic radiation elements 33 are designed for the second frequency band. The first parasitic radiation elements 33 are spaced apart with each and disposed at a side of the first resonated portion 322. The first parasitic radiation elements 33 are disposed symmetrically with each other along an axial line A perpendicular to a middle portion of the first resonated portion 322. The first parasitic radiation elements 33 extend along a direction perpendicular to the first resonated portion 322. The two parasitic elements 34 are corresponding to the second frequency band, and are disposed between the first parasitic radiation elements 33 and the first resonated portion 322 of the feeding element 32 respectively. Each of the parasitic elements 34 comprises a first parasitic portion 341 extending along a direction parallel to the first resonated portion 322, and a second parasitic portion 342 connecting with the first parasitic portion 341 and extending along a direction perpendicular to the first resonated portion 322. The parasitic elements 34 are disposed symmetrically with each other along an axial line A perpendicular to a middle portion of the first resonated portion 322. The two second parasitic radiation elements 35 are designed for the first frequency band, and are disposed spaced apart from the feeding element 32 and adjacent to opposite ends of the first resonated portion 322. Each of the second parasitic radiation elements extends along a direction perpendicular to the first resonated portion 322. The second parasitic radiation elements are disposed symmetrically with each other along the axial line A. The third parasitic radiation element 36 is designed for the third frequency band, and is disposed adjacent to an end of the second resonated portion 323. The third parasitic radiation element extends along a direction perpendicular to the first direction.

The multiband antenna 30 of the third embodiment is according with the WiMax standard and the WiFi standard. The first frequency band is 2.3-2.7 GHz, and the second frequency band is 3.3-3.8 GHz, and the third frequency band is 5.1-5.8 GHz. The second frequency band is close to the first frequency band. Therefore, it is difficult to add the second frequency band resonation on the feeding element 32. The parasitic element 34 is used for the first parasitic radiation element 33 to work at the second frequency band. The first parasitic radiation element 33 has a length equal to a half or a quarter of a wavelength of a central frequency of the second frequency band. The second parasitic radiation element 35 has a length equal to a half or a quarter of a wavelength of a central frequency of the first frequency band. The third parasitic radiation element 36 has a length equal to a half or a quarter of a central frequency of the third frequency band. The parasitic element 34 has a length equal to a quarter of a wavelength of a central frequency band of the second frequency band.

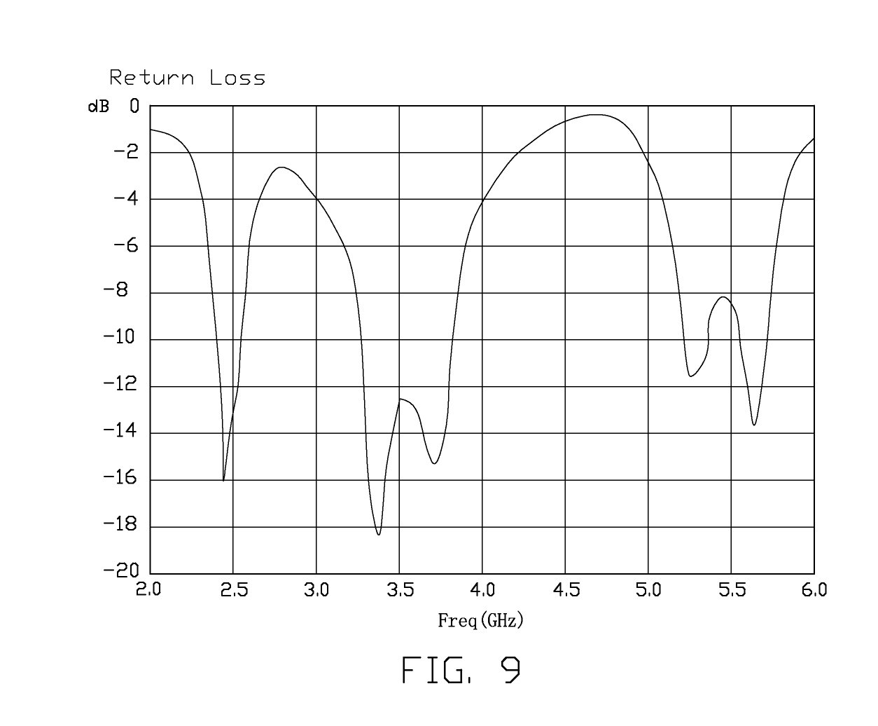

Referring to FIG. 9, a simulation result graph showing return loss versus frequency characteristic of the multiband antenna 30 in accordance with the third embodiment.

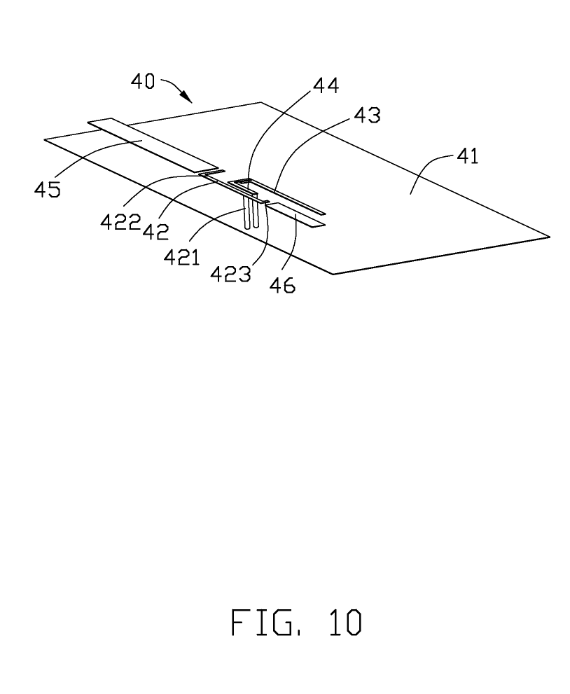

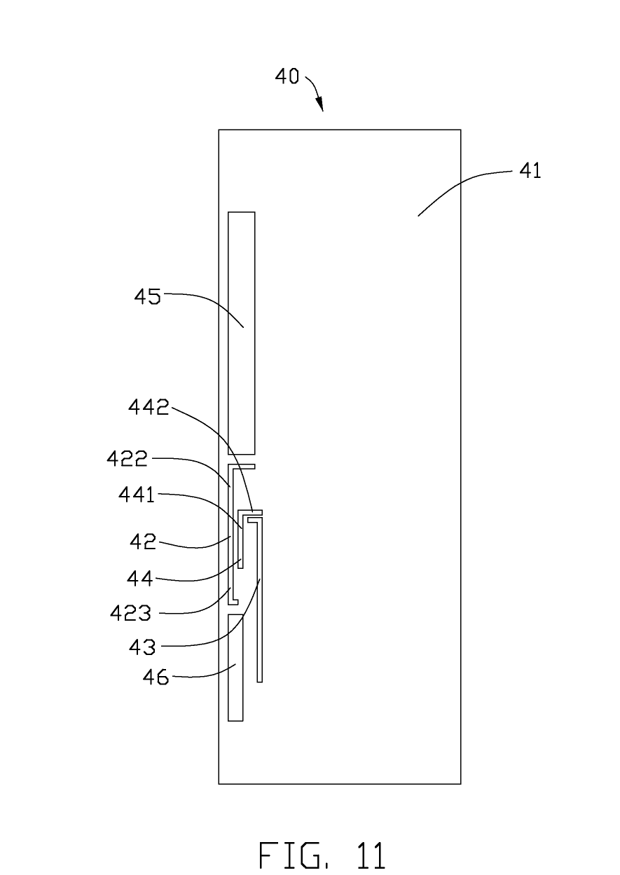

Referring to FIGS. 10 to 12, a multiband antenna 40 in accordance with a fourth embodiment of the present invention having a small size comprises a grounding element 41, a feeding element 42, a first parasitic radiation element 43, a parasitic element 44, a second parasitic radiation element 45, and a third parasitic radiation element 46. The grounding element 41 is disposed on a first plane. The feeding element 42, the first parasitic radiation element 43, the parasitic element 44, the second parasitic radiation element 45, and the third parasitic radiation element 46 are disposed on a second plane spaced apart from and parallel to the first plane. As an example, a distance between the first plane and the second plane is equal to 7 mm.

The feeding element 42 extending along a first direction comprises a connecting portion 421 for connecting with a power feed line, e.g., a coaxial connector, a first resonated portion 422 corresponding to the first frequency band, and a second resonated portion 423 corresponding to the third frequency band. The first parasitic radiation element 43 is designed for the second frequency band, and is disposed at a side of the feeding element 42 extending along a direction parallel to the first direction. The parasitic element 44 is corresponding to the second frequency disposed between the first parasitic radiation element 43 and the feeding element 42. The parasitic element 44 comprises a first parasitic portion 441 extending along a direction parallel to the first direction, and a second parasitic portion 442 connecting with the first parasitic portion 441 and extending along a direction perpendicular to the first direction. The second parasitic radiation element 45 is designed for the first frequency band, and is disposed spaced apart from the feeding element 42 and adjacent to an end of the first resonated portion 422. The second parasitic radiation element 45 extends along the first direction. The third parasitic radiation element 46 is designed for the third frequency band, and is disposed spaced apart from the feeding element 42 and adjacent to an end of the second resonated portion 423. The third parasitic radiation element 46 extends along the first direction.

The multiband antenna 40 of the fourth embodiment is according with the WiMax standard and the WiFi standard. The first frequency band is 2.3-2.7 GHz, and the second frequency band is 3.3-3.8 GHz, and the third frequency band is 5.1-5.8 GHz. The second frequency band is close to the first frequency band. Therefore, it is difficult to add the second frequency band resonation on the feeding element 42. The parasitic element 44 is used for the first parasitic radiation element 43 to work at the second frequency band. The first parasitic radiation element 43 has a length equal to a half of a wavelength of a central frequency of the second frequency band. The second parasitic radiation element 45 has a length equal to a half of a wavelength of a central frequency of the first frequency band. The third parasitic radiation element 46 has a length equal to a half of a central frequency of the third frequency band. The parasitic element 44 has a length equal to a quarter of a wavelength of a central frequency band of the second frequency band. The multiband antenna 40 has a length in first direction equal to 105 mm, and a width in a direction perpendicular to the first direction equal to 7 mm.

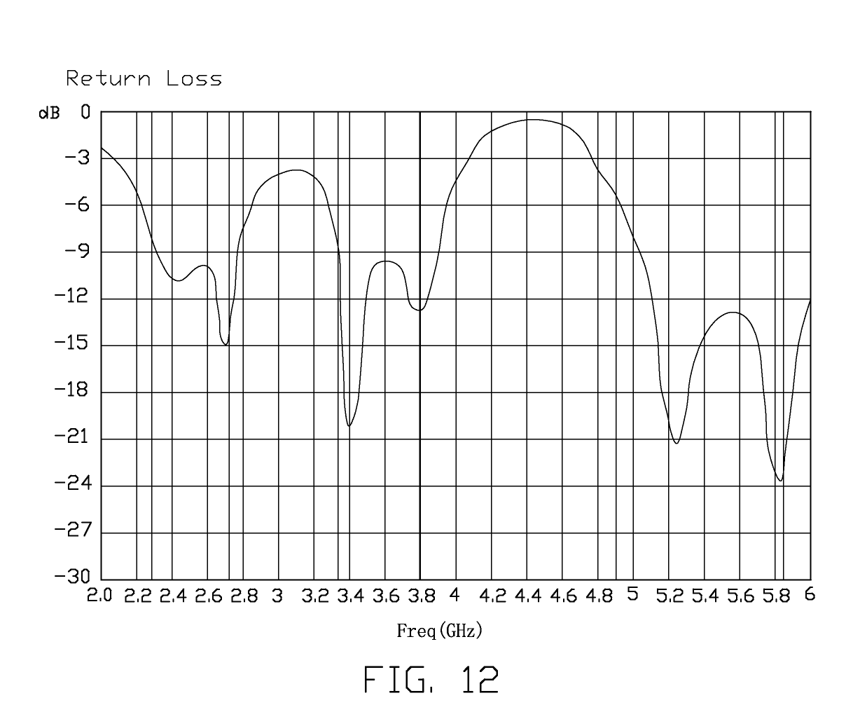

Referring to FIG. 12, a simulation result graph showing return loss versus frequency characteristic of the multiband antenna 40 in accordance with the fourth embodiment.

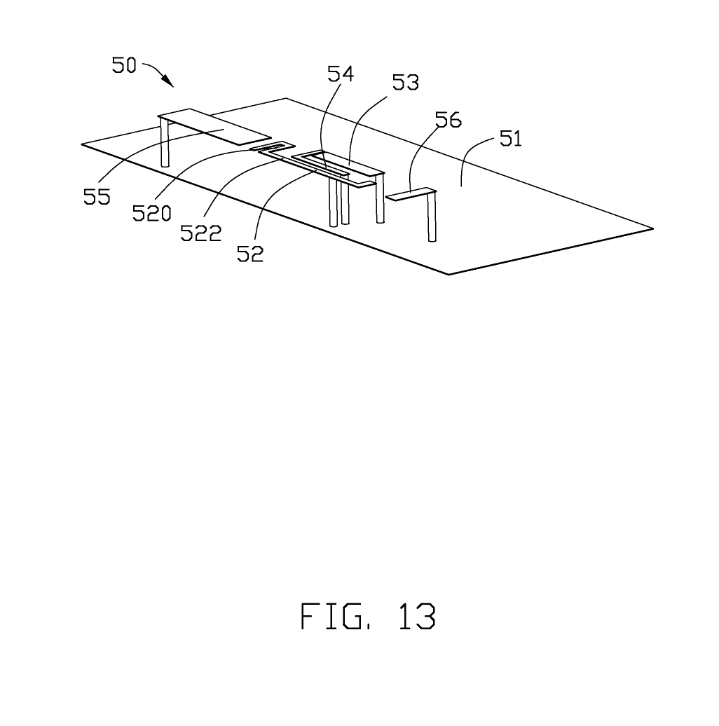

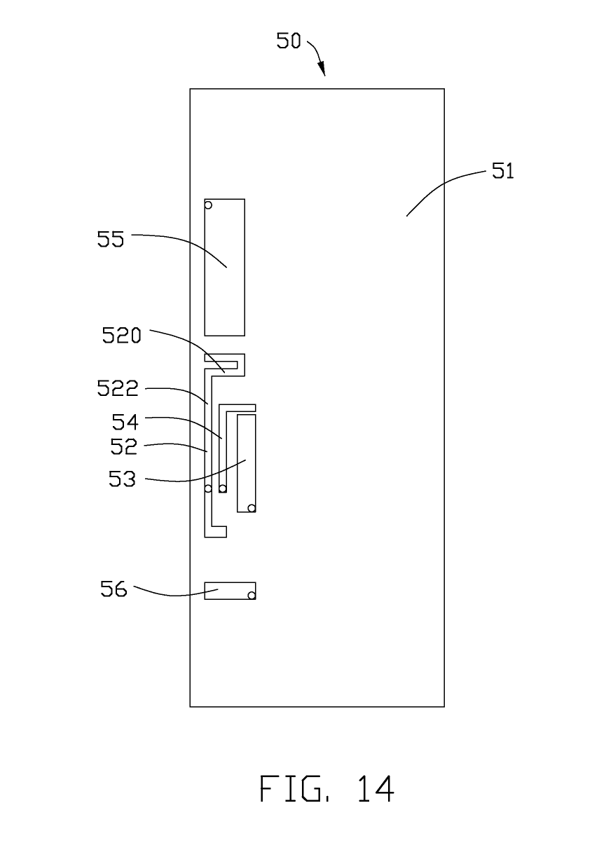

Referring to FIGS. 13 to 15, a multiband antenna 50 in accordance with a fifth embodiment of the present invention comprises a grounding element 51, a feeding element 52 extending along a first direction, a first parasitic radiation element 53, a parasitic element 54, a second parasitic radiation element 55, and a third parasitic radiation element 56. Each of the parasitic radiation elements 53, 55, 56 has a length equal to a quarter of wavelength of a central frequency of the corresponding frequency band. The feeding element 52 comprises a first resonated portion 522. A main distinction between the fifth embodiment and the fourth embodiment of the multiband antenna 50, 40 is the feeding element 52 comprising a bending portion 520 to reduce the length of the feeding element 52. Therefore, the multiband antenna 50 has a length in first direction equal to 55 mm, and a width in a direction perpendicular to the first direction equal to 7 mm.

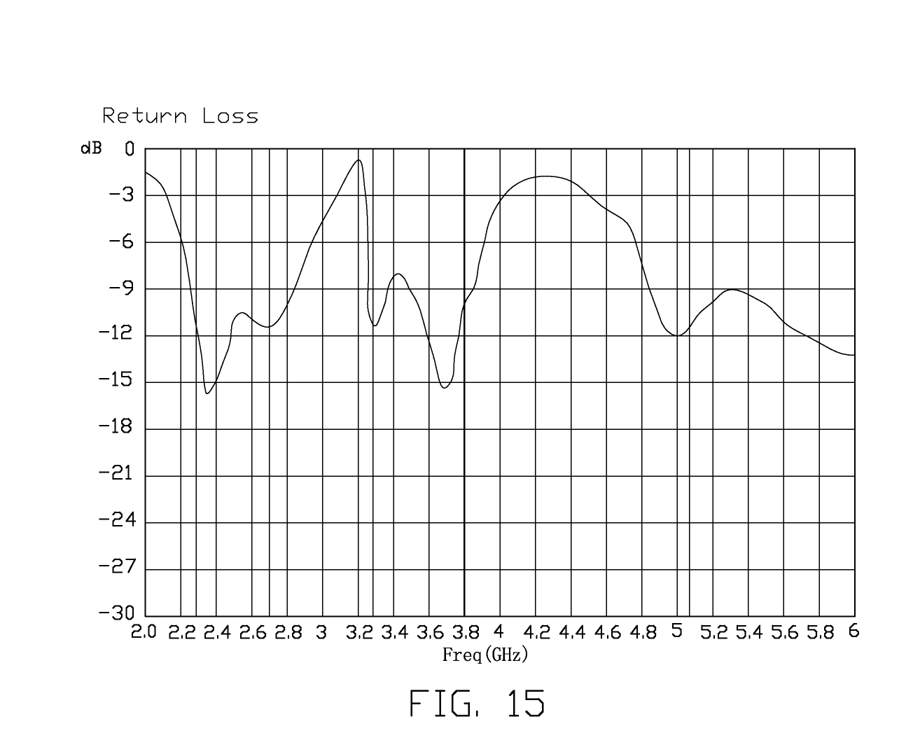

Referring to FIG. 15, a simulation result graph showing return loss versus frequency characteristic of the multiband antenna 50 in accordance with the fifth embodiment.

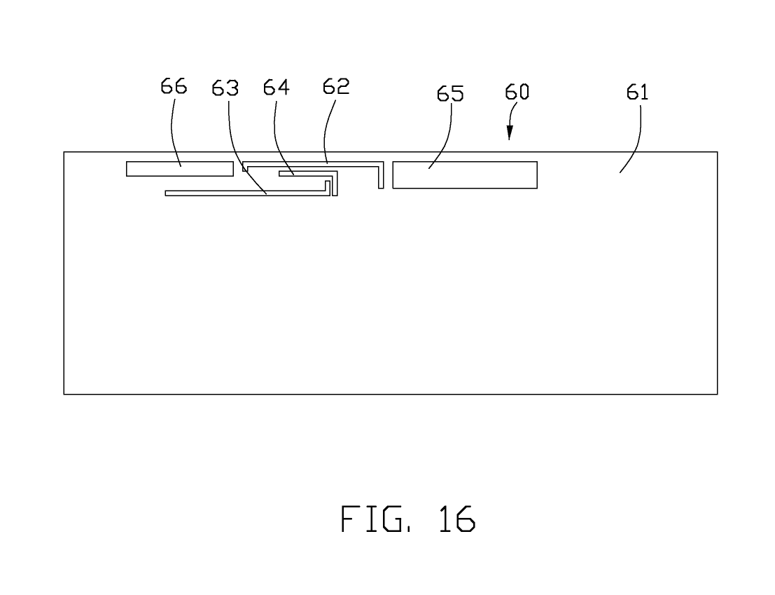

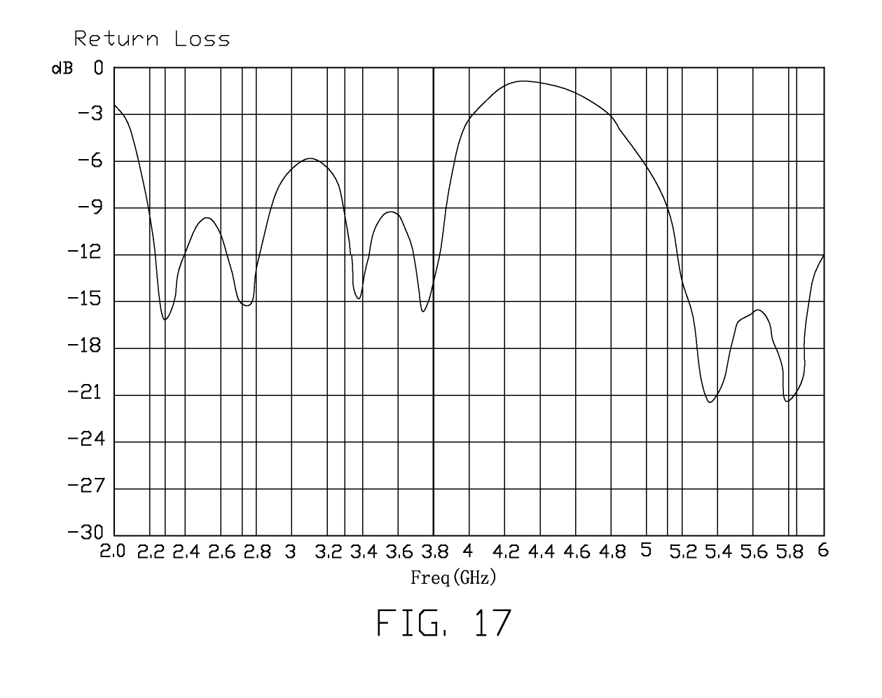

Referring to FIGS. 16 and 17, a multiband antenna 60 in accordance with a sixth embodiment of the present invention comprises a grounding element 61, a feeding element 62 extending along a first direction, a first parasitic radiation element 63, a parasitic element 64, a second parasitic radiation element 65 being connected with the grounding element 61, and a third parasitic radiation element 66. A main distinction between the sixth embodiment and the fourth embodiment of the multiband antenna 60, 40 is the second parasitic radiation element 65 having a length equal to a quarter of a wavelength of a central frequency of the first frequency band. Therefore, the multiband antenna 60 has a length in first direction equal to 75 mm, and a width in a direction perpendicular to the first direction equal to 7 mm.

Referring to FIG. 17, a simulation result graph showing return loss versus frequency characteristic of the multiband antenna 60 in accordance with the sixth embodiment.

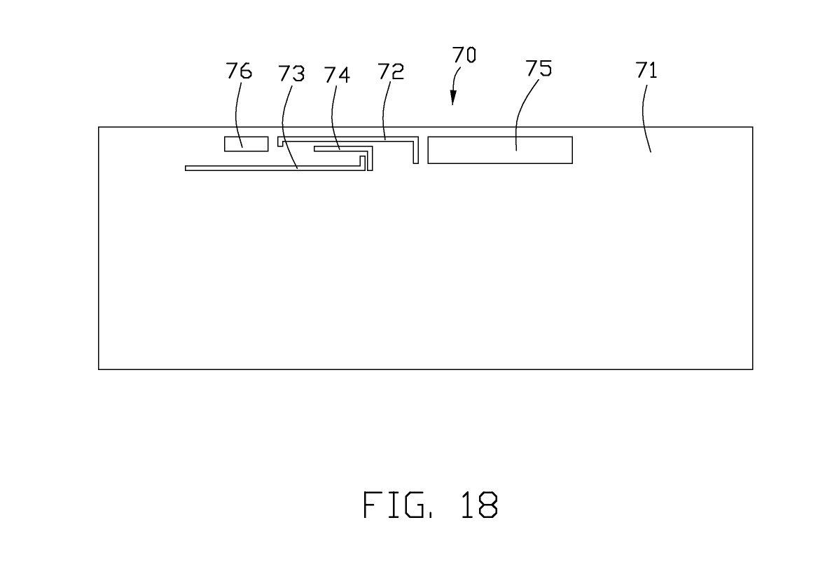

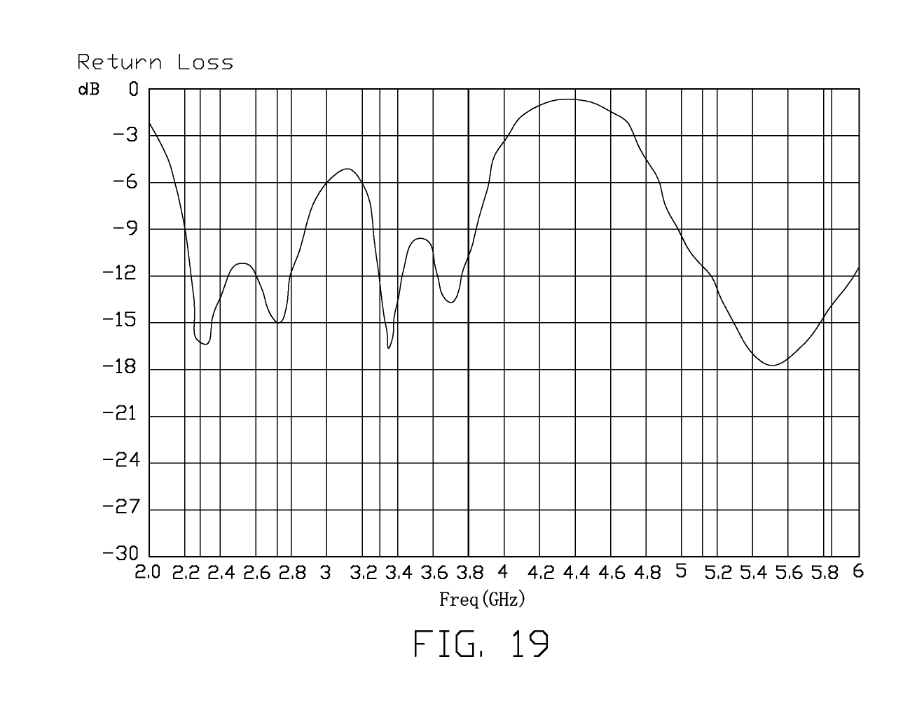

Referring to FIGS. 18 and 19, a multiband antenna 70 in accordance with a seventh embodiment of the present invention comprises a grounding element 71, a feeding element 72 extending along a first direction, a first parasitic radiation element 73, a parasitic element 74, a second parasitic radiation element 75 being connected with the grounding element 71, and a third parasitic radiation element 76 being connected with the grounding element 71. A main distinction between the seventh embodiment and the sixth embodiment of the multiband antenna 70, 60 is the third parasitic radiation element 76 having a length equal to a quarter of a wavelength of a central frequency of the third frequency band. Therefore, the multiband antenna 70 has a length in first direction equal to 67 mm, and a width in a direction perpendicular to the first direction equal to 7 mm.

Referring to FIG. 19, a simulation result graph showing return loss versus frequency characteristic of the multiband antenna 70 in accordance with the seventh embodiment.

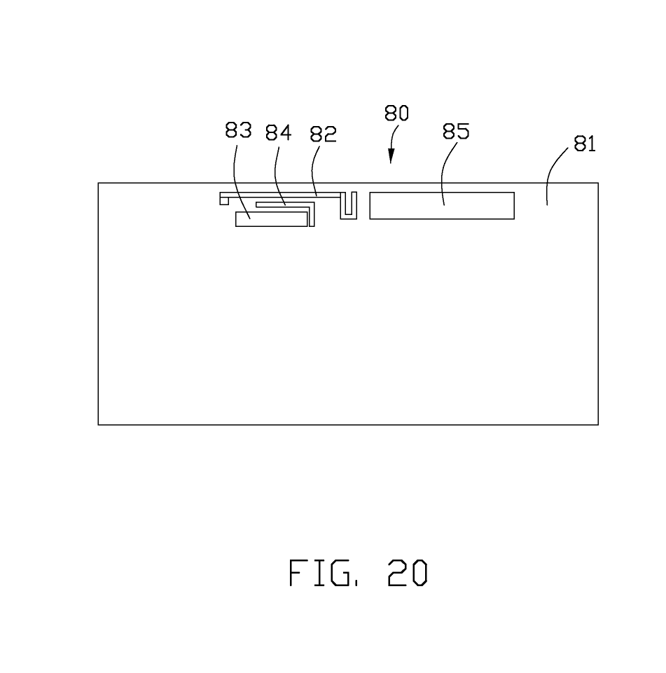

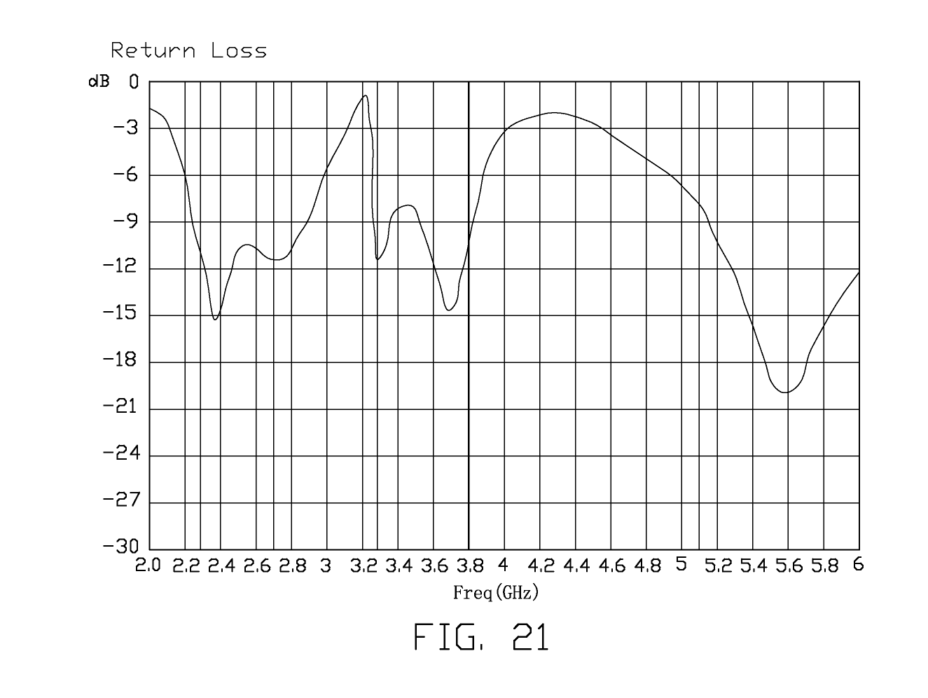

Referring to FIGS. 20 and 21, a multiband antenna 80 in accordance with a eighth embodiment of the present invention comprises a grounding element 81, a feeding element 82, and a first parasitic radiation element 83 being connected with the grounding element 81, a parasitic element 84, and a second parasitic radiation element 85 being connected with the grounding element 81. A main distinction between the eighth embodiment and the fifth embodiment of the multiband antenna 80, 50 do not have a third parasitic radiation element. Therefore, the multiband antenna 80 has a smallest a length in first direction equal to 46.5 mm, and a width in a direction perpendicular to the first direction equal to 7 mm.

Referring to FIG. 21, a simulation result graph showing return loss versus frequency characteristic of the multiband antenna 80 in accordance with the eighth embodiment.

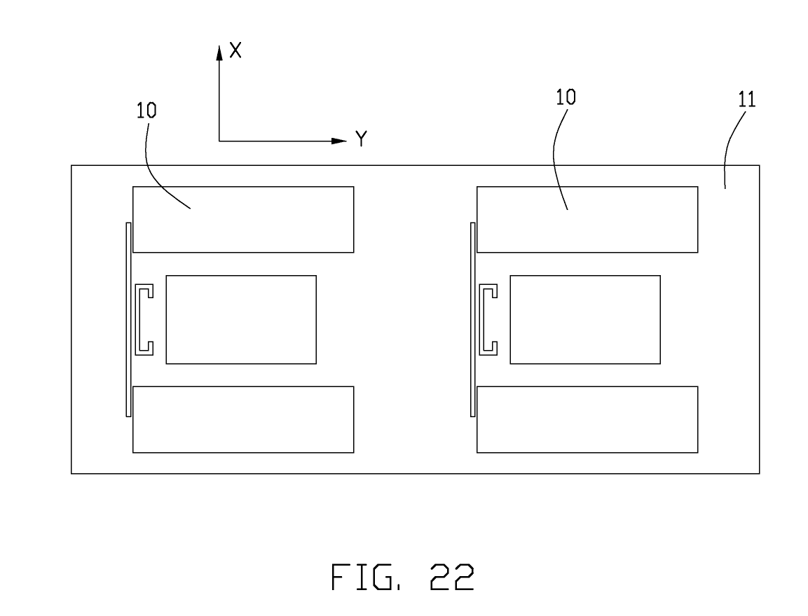

Referring to FIG. 22, a multiband antennae array comprises a plurality of first embodiment multiband antennae 10 arranged in a Y direction. The multiband antennae array could comprise a plurality of other embodiment's multiband antennae 20-80 arranged in a Y direction, or a X direction, or X and Y directions.

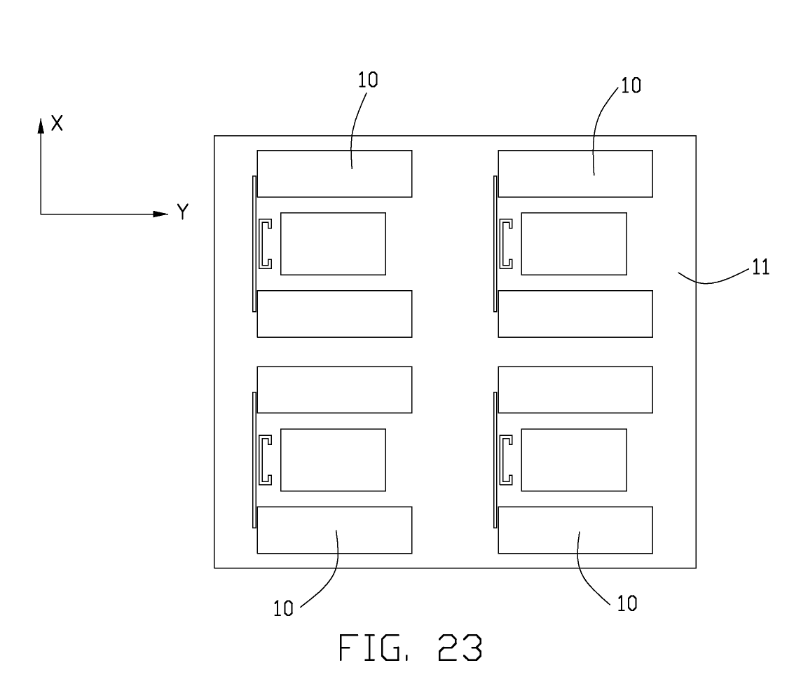

Referring to FIG. 23, a multiband antennae array comprises four first embodiment's multiband antennae 10 arranged in the X and Y directions. As an example, a distance between the adjacent multiband antennae along the X direction is about 80 mm, and a distance between the adjacent multiband antennae along the Y direction is about 100 mm. The multiband antenna array comprises a grounding element 11 having a dimension in the X direction equal to 150 mm, a dimension in the Y direction equal to 180 mm, and a dimension in a direction perpendicular to the X and the Y direction equal to 7 mm.

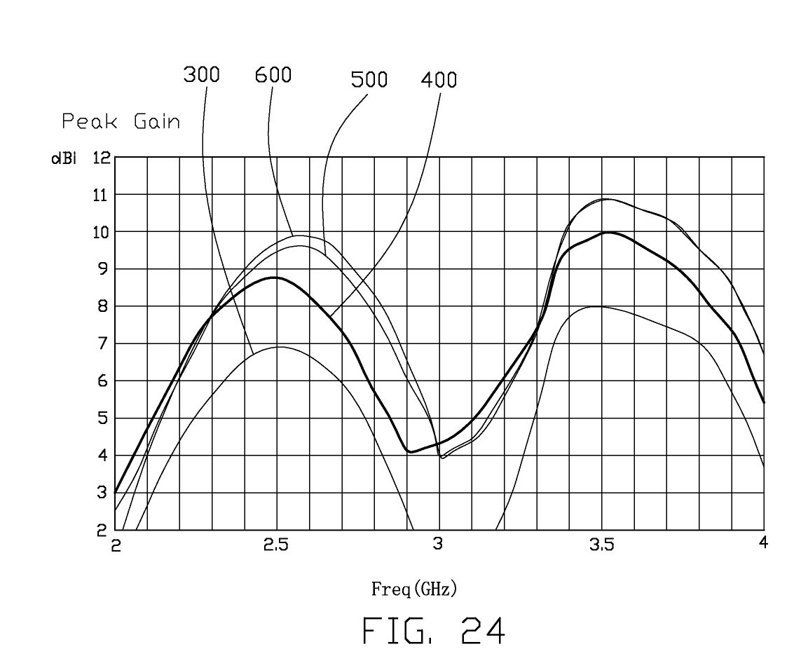

Referring to FIG. 24, a different simulation results graph shows peak gains versus frequency characteristic of different distances between the adjacent multiband antennas 10 of the multiband antennae array as shown in FIG. 22. The graph comprises a first curve 300 showing peak gain versus frequency characteristic of only one multiband antenna 10, a second curve 400 showing two multiband antennae's 10 peak gain versus frequency characteristic of a distance between them in the Y direction equal to 60 mm, a third curve 500 showing two multiband antennae's 10 peak gain versus frequency characteristic of a distance between them in the Y direction equal to 80 mm, and a fourth curve 600 showing two multiband antennae's 10 peak gain versus frequency characteristic of a distance between them in the Y direction equal to 100 mm.

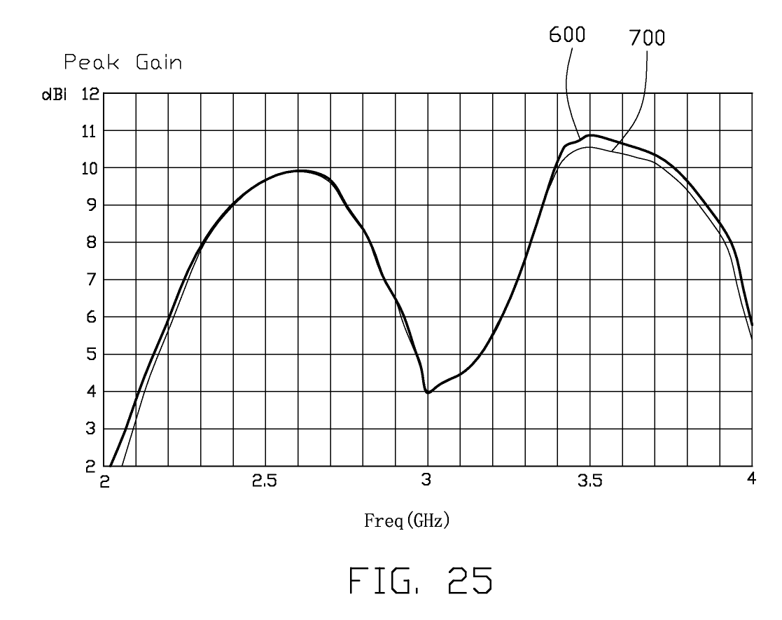

Referring to FIGS. 25, a different simulation results graph shows peak gains versus frequency characteristic of different distances between the adjacent multiband antennas of the multiband antennae array as shown in FIG. 22. The graph comprises the fourth curve 600 showing two multiband antennae's 10 peak gain versus frequency characteristic of a distance between them in the Y direction equal to 100 mm, and a fifth cure 700 showing two multiband antennae's 10 peak gain versus frequency characteristic of a distance between them in the Y direction equal to 120 mm. The fifth cure 700 is almost same as the fourth cure 600.

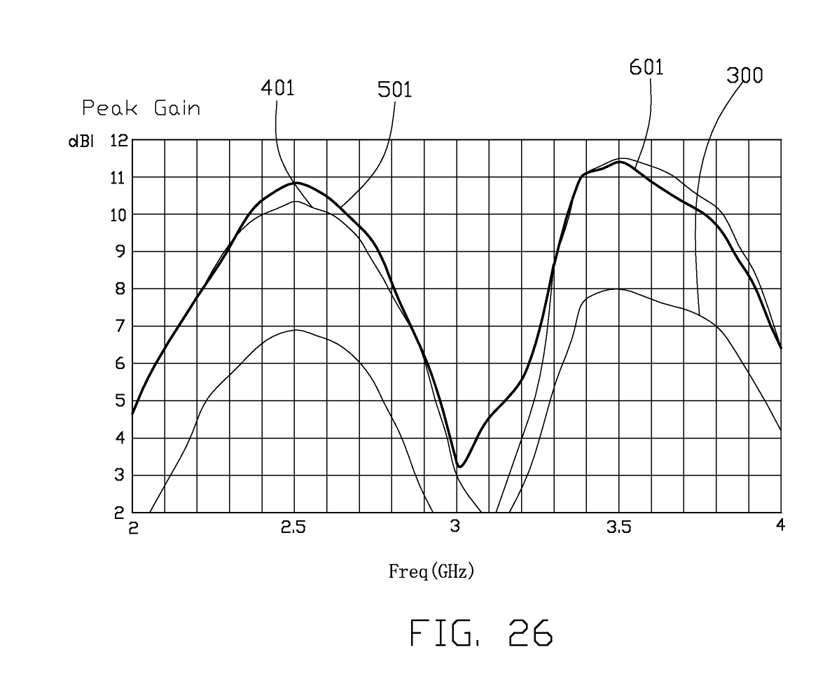

Referring to FIG. 26, a different simulation results graph shows peak gains versus frequency characteristic of different distances between the adjacent multiband antennas of the multiband antennae array arrange in the X direction and in the Y direction. The graph comprises a sixth curve 401 showing peak gain versus frequency characteristic of two multiband antennae's 10 peak gain versus frequency characteristic of a distance between them in the X direction equal to 80 mm, a seventh curve 501 showing peak gain versus frequency characteristic of two multiband antennae's 10 peak gain versus frequency characteristic of a distance between them in the X direction equal to 100 mm, and an eight cure 601 showing peak gain versus frequency characteristic of two multiband antennae's 10 peak gain versus frequency characteristic of a distance between them in the X direction equal to 120 mm.

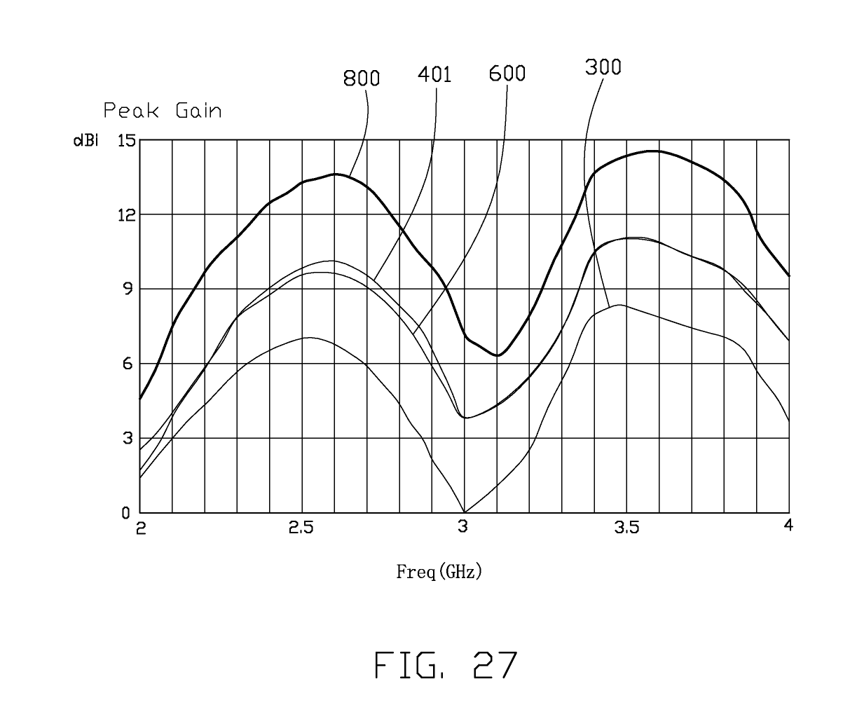

Referring to FIG. 27, a different simulation results graph shows peak gains versus frequency characteristic of different distances between the adjacent multiband antennas 10 of the multiband antennae array arranged in the X direction, Y direction, and the X and the Y direction. The graph comprises a ninth curve 800 showing peak gain versus frequency characteristic of four multiband antennae's 10 peak gain versus frequency characteristic of a distance between them in the X direction equal to 80 mm and in the Y direction equal to 100 mm.

The multiband antenna 10-80 and multiband antennae array of this invention can work at close frequency bands, and have simply structure. The multiband antenna 10-80 and multiband antennae array can be only metal parts or PCB based.

It is to be understood, however, that even though numerous characteristics and advanarmes of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multiband antenna comprising:
a grounding element;
a feeding element resonating at a first frequency band;
a first parasitic radiation element spaced apart from the feeding element, the first parasitic radiation element being designed for operating at a second frequency band; and
a parasitic element disposed between the first parasitic radiation element and the feeding element for operating at the second frequency band.

2. The multiband antenna as recited in claim 1, further comprising a second parasitic radiation element spaced apart from the feeding element for operating at the first frequency band.

3. The multiband antenna as recited in claim 2, wherein the feeding element comprises a first portion resonating at the first frequency band and a second portion resonating at a third frequency band.

4. The multiband antenna as recited in claim 3, further comprising a third parasitic radiation element disposed adjacent to the second portion for operating at the third frequency band.

5. The multiband antenna as recited in claim 4, wherein the parasitic element extends along a first direction, and the first parasitic radiation element extends along a second direction perpendicular to the first direction.

6. The multiband antenna as recited in claim 4, wherein the parasitic element extends along a first direction, and the first parasitic radiation element extends along a second direction parallel to the first direction.

7. The multiband antenna as recited in claim 4, wherein the feeding element extends along a third direction, and the second parasitic radiation element extends along a fourth direction perpendicular to the third direction.

8. The multiband antenna as recited in claim 4, wherein the feeding element extends along a third direction, and the second parasitic radiation element extends along a fourth direction parallel to the third direction.

9. The multiband antenna as recited in claim 3, wherein the first frequency band is 2.3-2.7 GHz, and the second frequency band is 3.3-3.8 GHz, and the third frequency band is 5.1-5.8 GHz.

10. The multiband antenna as recited in claim 9, wherein the second frequency band has a central frequency corresponding to a second wavelength, the first parasitic radiation element having a first length equal to a half or a quarter of the second wavelength.

11. The multiband antenna as recited in claim 9, wherein the second frequency band has a central frequency corresponding to a second wavelength, the parasitic element having a length equal to a half of the second wavelength.

12. The multiband antenna as recited in claim 9, wherein the first frequency band has a central frequency corresponding to a first wavelength, the second parasitic radiation element having a second length equal to a quarter of the first wavelength.

13. The multiband antenna as recited in claim 9, wherein the third frequency band has a central frequency corresponding to a third wavelength, the third parasitic radiation element having a third length equal to a quarter of the third wavelength.

14. The multiband antenna as recited in claim 1, wherein the grounding is disposed on a first plane, and the feeding element and the first parasitic radiation element are disposed on a second plane spaced apart from and parallel to the first plane, a distance between the first plane and the second plane being equal to 7 mm.

15. A multiband antennae array comprising:
a plurality of multiband antennae arranged in a plurality of rows and a plurality of columns, each of the multiband antennae comprising:
a grounding element;
a feeding element resonating at a first frequency band;
a first parasitic radiation element spaced apart from the feeding element, the first parasitic radiation element being designed for operating at a second frequency band; and
a parasitic element disposed between the first parasitic radiation element and the feeding element for operating at the second frequency band.

16. The multiband antennae array as recited in claim 15, wherein each of the multiband antennae comprises a second parasitic radiation element spaced part from the feeding element for operating at the first frequency band.

17. The multiband antennae array as recited in claim 15, wherein the feeding elements extend along a first direction, and the first parasitic radiation elements extend along a second direction perpendicular to the first direction, a first distance between each of the adjacent multiband antennae along the first direction being equal to 100 mm, and a second distance between the adjacent multiband antennae along the second direction being equal to 80 mm.

18. The multiband antenna comprising:
a grounding element;
a feeding element resonating at a first frequency band;
at least two parasitic radiation elements located beside and spaced from the feeding element wherein one of said at least two parasitic radiation elements works at the a second frequency band; and
a parasitic element located adjacent to and spaced from both the feeding element and said one of the at least two parasitic radiation elements for helping said one of the at least two parasitic radiation elements work at the second frequency band.

19. The multiband antenna as claimed in claim 18, wherein both the at least two parasitic radiation element are significantly larger than the feeding element.

20. The multiband antenna as claimed in claim 18, wherein said parasitic element is essentially located between the feeding element and said one of the at least two parasitic radiation elements.
